(19) United States
(12) Patent Application Publication
(10) Pub. No.: US 2020/0234214 A1
(43) Pub. Date: Jul. 23, 2020

(54) INFORMATION PROCESSING SYSTEM

(71) Applicant: Maruichi Warehouse Co., Ltd., Yamanashi (JP)

(72) Inventor: Makoto HORIUCHI, Kofu-shi (JP)

(73) Assignee: Maruichi Warehouse Co., Ltd., Yamanashi (JP)

(21) Appl. No.: 16/486,294

(22) PCT Filed: Feb. 27, 2018
(86) PCT No.: PCT/JP2018/007357

§ 371 Date: Aug. 15, 2019

(30) Foreign Application Priority Data
Feb. 27, 2017 (JP) 2017-035471

(51) Int. Cl. G06Q 10/06; G06Q 30/06; G06Q 10/08; G06Q 10/10

(52) U.S. Cl. CPC G06Q 10/06375; G06Q 30/0635; G06Q 10/06395; G06Q 10/10; G06Q 10/0838

(57) ABSTRACT

The present invention makes it possible for a person (a sender or a third party) that is not on a production side or a distribution side to form a distribution plan. According to the present invention, a received-order-information acquisition unit 61 acquires sender S side received-order information. (information on an order from a customer C or information on an order placed to a vendor V (a production/supply source)) from a sender terminal 3 or a vendor terminal 4 via a communication unit 19. A received-order-to-distribution conversion unit 62 converts the acquired received-order information into distribution information. (information on arrival from the vendor V (the production/supply source), information on shipping to the customer C). A parameter acquisition unit 63 acquires, from a parameter DB 71, parameters that include at least deadline, cost, and quality (accident rate). A distribution-plan generation unit 64 generates a distribution plan (when, where, who) on the basis of the distribution information as converted by the received-order-to-distribution conversion unit 62 and the parameters acquired by the parameter acquisition unit 63.

### TECHNICAL FIELD

The present invention relates to an information processing system.

### BACKGROUND ART

In recent years, the importance of a distribution system has been increasing more and more, and the distribution system is an indispensable technology in daily life. Therefore, people are highly interested in the cost and the quality for using the distribution system, and there is a demand for the development of technology to operate the distribution system efficiently. In this regard, a technique for managing a distribution business plan, execution of a work according to a plan, and an actual record has also been proposed (for example, see Patent Document 1). According to the technique described in Patent. Document 1, transport of arts when parts are delivered from multiple suppliers to produce finished products is planned. Such a technique is very useful when a producer makes a distribution plan as a distribution side.

Patent Document 1: Japanese Unexamined Patent Application, Publication No. 2014-214022

### DISCLOSURE OF THE INVENTION

### Problems to be Solved by the Invention

However, in the technique described in Patent Document 1, only people on the production side or the distribution side person can make the distribution plan, and for this reason, those (the sender and the third party) who are not the production side or the distribution side are unable to do distribution marketing or the like through various types of simulations, analysis, or the like.

The present invention was made in light of the foregoing, and it is an object of the present invention to provide a technique that enables those (the sender and the third party) who are not the production side or the distribution side to make the distribution plan since higher-order information (received-order information) on the sender side can be converted into lower-order distribution information. Accordingly, it is possible to do distribution marketing or the like through various types of simulations, analysis, or the like.

### Means for Solving the Problems

In order to achieve the above objects, an information processing system of one aspect of the present invention includes:
a received-order-information acquisition section that acquires received-order information on a sender side (the order information from the customer, the placed order information to the production/supply source, or the like) from a sender terminal or a vendor (production/supply source) terminal;
a received-order-to-distribution conversion section that converts the acquired received-order information into distribution information (the information on arrival from the production/supply source and the information on shipping to the customer);
a parameter acquisition section that acquires parameters including at least a deadline, a cost, and a quality (accident rate); and
a distribution-plan generation section that generates distribution plan (when, where, and who) on the basis of the converted distribution information and the acquired parameters.

### Effects of the Invention

According to the present invention, it is possible to provide a technique that enables those (the sender and the third party) who are not the distribution side to make the distribution plan as higher-order information (received-order information) on the sender side can be converted into lower-order distribution information.

### BRIEF DESCRIPTION OF THE DRAWINGS

FIG. 1 is a block diagram illustrating a configuration of an information processing system according to an embodiment of the present invention.

FIG. 2 is a block diagram illustrating a hardware configuration of a server of an embodiment of the present invention in the information processing system of FIG 1.

FIG. 3 is a functional block diagram illustrating an example of functional configurations of a server, a customer terminal, a sender terminal, a vendor terminal, and a distribution service provider terminal in FIG. 2.

FIG. 4 is a diagram illustrating an overall view a distribution service that executes a distribution plan which is made on the basis of a distribution plan generation process executed by the server of FIG. 3.

FIG. 5 is a flowchart for describing the flow of the distribution plan generation process executed by the server of FIG. 3.

FIG. 6 is a diagram illustrating an example of a service different from that of FIG. 4 among services performed by a service provider that executes a distribution plan generation process executed by the server of FIG. 3.

### PREFERRED MODE FOR CARRYING OUT THE INVENTION

Hereinafter, an embodiment of the present invention will be described with reference to the appended drawings.

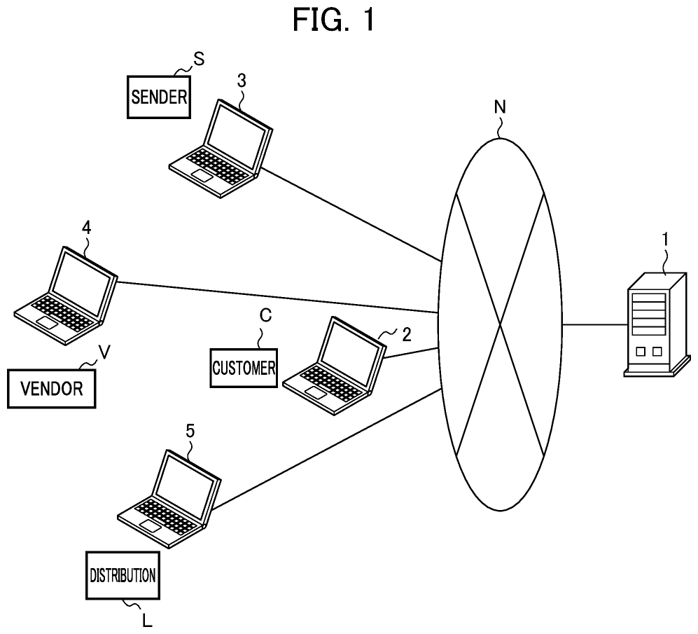

FIG. 1 illustrates a configuration of an information processing system according to an embodiment of the present invention.

As illustrated in FIG. 1, the information processing system of the present embodiment includes a server 1 managed by a package transport service provider, customer terminals 2-1 to 2-m used by m (m is an arbitrary integer value of 1 or more) customers C, sender terminals 3-1 to 3-n used by m (m is an arbitrary integer value of 1 or more) senders S, vendor terminals 4-1 to 4-p used by m (m is an arbitrary integer value of 1 or more) vendors and distribution service provider terminals 5-1 to 5-m used by m (m is an arbitrary integer value of 1 or more) distribution service providers L. The server 1, the customer terminal s 2-1 to 2-m, the sender terminals 3-1 to 3-m, the vendor terminals 4-1 to 4-m, and the distribution service provider terminal 5-1 to 3-m are connected to one another via a predetermined network N such as the Internet.

Hereinafter, the customer terminals 2-1 to 2-m are referred to collectively as a “customer terminal 2” when there is no need to distinguish each of them, the sender terminals 3-1 to 3-m are referred to collectively as a “sender terminal 3” when there is no need to distinguish each of them, the vendor terminals 4-1 to 4-m are referred to collectively as a “vendor terminal ” when there is no need to distinguish each of them, and the distribution service provider terminals 5-1 to 5-m are referred to collectively as a “distribution service provider terminal 5” when there is no need to distinguish each of them. Here, in the present embodiment, the customer C, the sender S, vendor V, and the distribution service provider L are all described as being equal in number, but the present invention is not limited thereto. That is, the numbers of people for the customer C, the sender S, vendor V, and the distribution service provider L can be different. In the present embodiment, it is explained that the customer terminal 2, the sender terminal 3, the vendor terminal 4, and the distribution service provider terminal 5 are equal in number, but the present invention is not limited thereto. That is, the numbers of various types of terminals may be different and can be freely set by the present service provider. In the present embodiment, the m customers C are described as using the m customer terminals 2, but the present invention is not limited thereto. That is, the number of customers C and the number of customer terminals 2 may be different. The same applies to the sender S and the sender terminal 3, the vendor V and the vendor terminal 4, the distribution service provider L and the distribution service provider terminal 5. The “vendor” in the present invention refers to a product production/supply source.

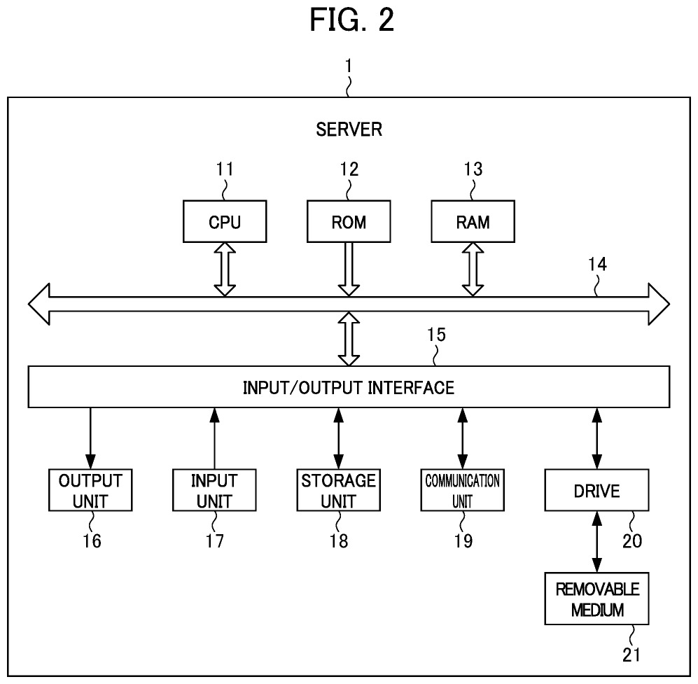

FIG. 2 is a block diagram illustrating a hardware configuration of the server 1 in the information processing system of FIG. 1.

The server 1 includes a central processing unit (CPU) 11, a read only memory (ROM) 12, a random access memory (RAM) 13, a bus 14, an input/output interface 15, an output unit 16, an input unit 17, a storage unit 18, a communication unit 19, and a drive 20.

The CPU 11 executes various types of processes in accordance with various types of programs recorded in the ROM 12 or various types of programs loaded from the storage unit 18 to the RAM 13. The RAM 13 also stores data necessary for the CPU 11 to execute various types of processes.

The CPU 11, the ROM 12, and the RAM 13 are connected to one another via the bus 14. The input/output interface 15 is also connected to the bus 14. The output unit 16, the input unit 17, the storage unit 18, the communication unit 19, and the drive 20 are connected to the input/output interface 15.

The output unit 16 includes various types of liquid crystal displays and outputs various types of information. The input unit 17 includes various types of hardware and receives various types of information. The storage unit 18 includes a hard disk, a dynamic random access memory (DRAM), or the like, and stores various types of data. The communication unit 19 controls communication with other devices (for example, the sender terminal 3, the distribution service provider terminal 5, or the like in FIG. 1) via the network N including the Internet.

The drive 20 is installed if necessary. A removable medium 21 including a magnetic disk, an optical disk, a magneto-optical disk, a semiconductor memory, or the like is appropriately mounted on the drive 20. A program read from the removable medium 21 by the drive 20 is installed in the storage unit 18 if necessary. The removable medium 21 can also store various types of data stored in the storage unit 18, similarly to the storage unit 18.

Configurations of the customer terminal 2, the sender terminal 3, the vendor terminal 4, and the distribution service provider terminal 5 are basically similar to the configuration of the server 1, description thereof is omitted here.

The following series of processes (hereinafter referred to as a “distribution plan generation process”) can be executed with cooperation of various types of hardware and various types of software of the server 1, the customer terminal 2, the sender terminal 3, the vendor terminal 4, and the distribution service provider terminal 5 of FIG. 2.

That is, the customer terminal 2-P (P is an integer value between 1 to m) owned by a predetermined customer C receives information input by the customer C as order information, and transmits it to the sender terminal 3. Here, the order information is information on input results (a request and a desire) of the customer to predetermined items set by the sender and the service provider such as a type, a quantity, a delivery destination of product to be ordered, and a date to deliver a product to be ordered to a delivery destination (hereinafter referred to as a “deadline”). Then, if the sender S that owns the sender terminal 3 inputs information necessary on the basis of the order information, the sender terminal 3 receives the input information as placed order information, and transmits it to the vendor terminal 4 and the server 1 with the order information. Here, the placed order information is information on input results (a request and a desire) of the sender to predetermined items set by the vendor and the service provider such as a type, a quantity, and a deadline of the product to be ordered. The service provider is a distribution plan generation service provider such as business operator that generates a distribution plan for product delivery on the basis of the order information and the placed order information. The server 1 acquires and manages various types of information related to package transport including at least information indicating characteristics of a product to be transported (for example, information such as a size, a weight, whether it is a refrigerated or frozen article, or the like. Hereinafter referred to as “package characteristic information”) and information indicating characteristics of the moving body that performs transport (for example, information such as a size such as a 4 t vehicle or a 10 t vehicle, a type of a route service or a reserved service. Hereinafter referred to as “moving body characteristic information”), feedback information from customers, and feedback information from the distribution service providers. Further, the server 1 transmits information on arrival and information on shipping generated by converting various types of information (information on arrival and information on shipping) to the distribution service provider terminal 5. The information on arrival is conversion information for predetermined items set by the distribution service provider and the service provider such as a type, a quantity, an arrival destination, a date of arrival, or the like of a product to be ordered. The information on shipping is conversion information for predetermined items set by the distribution service provider and the service provider such as a type, a quantity, a delivery destination, a deadline, or the like of a product to be ordered. Then, the server 1 allocates the distribution service provider to each arrival/shipment that constitutes the distribution information obtained by the conversion on the basis of the acquired parameters, determines “when,” “where,” and “who,” and generates the distribution plan. Any method can be employed as a method of determining “when,” “where,” and “who” by the server 1.

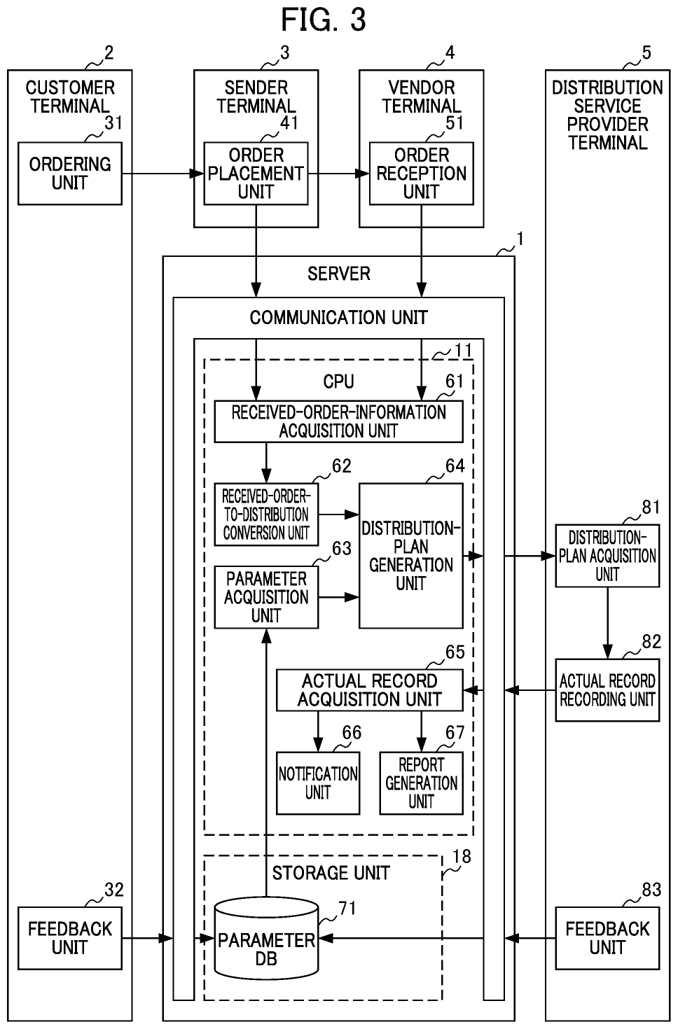

Such a series of processes is a distribution plan generation process. In order to realize the distribution plan generation process, the server 1, the customer terminal 2, the sender terminal 3, the vendor terminal 4, and the distribution service provider terminal 5 have the functional configurations illustrated in FIG. 3. FIG. 3 is a functional block diagram illustrating an example of functional configurations of the server 1, the customer terminal 2, the sender terminal 3, the vendor terminal 4, and the distribution service provider terminal 5 of FIG. 2.

In the customer terminal 2, an ordering unit 31 and a feedback unit 32 function. In the sender terminal 3, an order placement unit 41 functions. In the vendor terminal 4, an order reception unit 51 functions. In the distribution service provider terminal 5, a distribution-plan acquisition unit 81, an actual record recording unit 82, and a feedback unit 83 function. In the CPU 11 of the server 1, a received-order-information acquisition unit 61, a received-order-to-distribution conversion unit 62, a parameter acquisition unit 63, and a distribution-plan generation unit 64 function. A parameter DB 71 is disposed as one area of the storage unit 18 of the server 1.

The ordering unit 31 of the customer terminal 2 receives information input by an operation of the customer C as the order information via an input unit (not illustrated). In other words, the ordering unit 31 receives the order information for a predetermined item set by the sender and the service provider such as the type, the quantity, the delivery destination, or the deadline of product to be ordered. Further, the ordering unit 31 executes control for transmitting the order information received by the input unit to the sender terminal 3 via a communication unit (not illustrated). Accordingly, the order information transmitted to the sender terminal 3 is acquired by the sender terminal 3. Then, the sender terminal 3 combines the order information and inventory information, calculates a shortage, and generates or receives information based on an amount determined by the sender terminal 3 or the sender S if necessary in order to compensate for the calculated shortage as the placed order information. Further, the order placement unit 41 executes control for transmitting the placed order information to the vendor terminal 4 and the server 1 via a communication unit (not illustrated). At the same time, control for transmitting the order information to the server 1 via a communication unit (not illustrated) is performed. The feedback unit 32 receives evaluation information for the distribution service provider L input by the operation of the customer C through the input unit (not illustrated) as feedback information. The feedback unit executes control for transmitting the feedback information received by the input unit to the server 1 through a communication unit (not illustrated). In the server 1, the feedback information is stored in the parameter DB 71.

The received-order-information acquisition unit 61 of the server 1 acquires the received-order information on the sender S side (the order information from the customer C, the placed order information to the vendor (the production/supply source), or the like) from the sender terminal 3 or the vendor terminal 4 via a communication unit 19. The received-order-to-distribution conversion unit 62 converts the acquired received-order information into the distribution information (the information on arrival from the vendor V (the production/supply source) and the information on shipping to the customer C). Specifically, the placed order information is converted into the information on arrival, and the order information is converted into the information on shipping. Further, the parameter acquisition unit 63 acquires parameters including at least the deadline, the cost, and the quality (accident rate) from the parameter DB 71.

The distribution-plan generation unit 64 generates the distribution plan (when, where, and who) on the basis of the distribution information converted by the received-order-to-distribution conversion unit 62 and the parameters acquired by the parameter acquisition unit 63. The distribution-plan generation unit 64 transmits the generated distribution plan to the distribution service provider terminal 5 via the communication unit 19. An actual record acquisition unit 65 acquires an actual distribution record transmitted from the distribution service provider terminal 5 via the communication unit 19 notification unit 66 notifies of a timing for introducing a system related to the present invention on the sender S side on the basis of a comparison result between the distribution plan and the actual distribution record. A report generation unit 67 generates a report on the distribution of the sender S on the basis of the comparison result between the distribution plan and the actual distribution record.

The distribution-plan acquisition unit 81 of the distribution service provider terminal 5 acquires and manages various types of information related to package transport including at least the information on arrival and the information on shipping. The actual record recording unit 82 records various types of information related to an actual record based on the information on arrival and the information on shipping, and executes control for further transmission. The feedback unit 83 receives evaluation information for the sender S input by the operation of the distribution service provider L via the input unit. (not illustrated) as the feedback information. The feedback unit 83 executes control for transmitting the feedback information received by the input unit to the server 1 through a communication unit (not illustrated). In the server 1, the feedback information is stored in the parameter DB 71.

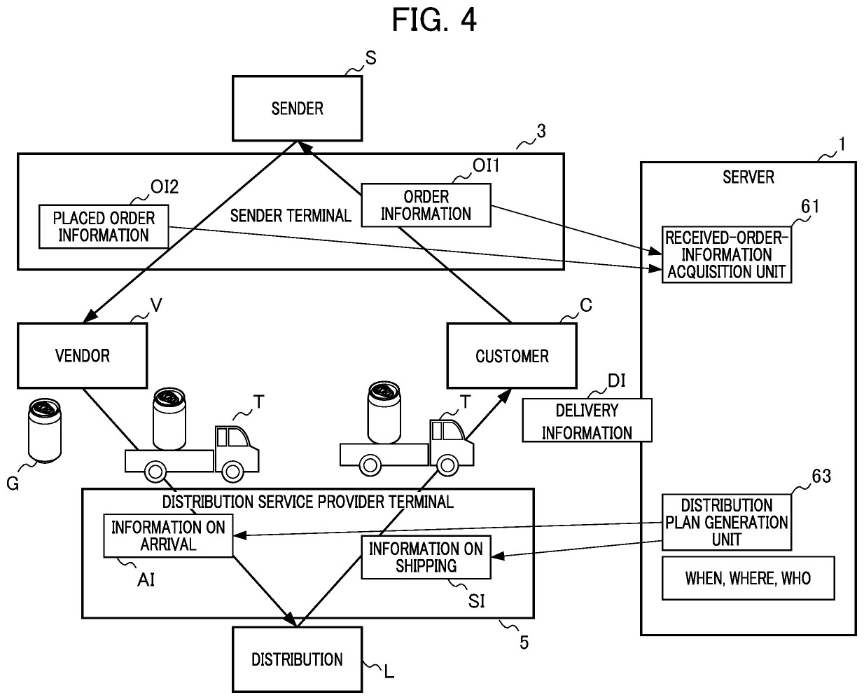

Next, an example of a service provided by the service provider will be described with reference to FIG. 4.

FIG. 4 is a diagram illustrating an example of a service performed by the service provider that executes the distribution plan generation process executed by the server of FIG. 3. Referring to FIG. 4, the customer C, the sender 5, the vendor V, the distribution service provider L, the server 1, the sender terminal 3, the distribution service provider terminal 5, delivery information DI, a product G, and the moving body T exists.

Further, the server 1 also includes the received-order-information acquisition unit 61 and the distribution-plan generation unit 64. Further, the sender terminal 3 includes order information OI1 and placed order information OI2. Further, the distribution service provider terminal 5 includes information on arrival AI and the information on shipping SI. The customer C operates the customer terminal 2 (not illustrated), transmits the order information OI1 to the sender terminal 3, and requests provision of the product G. Upon receiving the product G, the delivery information DI and the evaluation information for the distribution service provider 1 are transmitted to the server 1 as the feedback information. The delivery information DI may be generated in the server 1 by operating the customer terminal 2.

The sender S operates the sender terminal 3 to generate the placed order information OI2 in accordance with the order information OI1, causes the product G to be supplied to the vendor V, and causes the product G to be delivered to the distribution service provider L. The vendor V supplies the product G in accordance with the placed order information OI2 and delivers it to the distribution service provider L.

The distribution service provider L receives the product from the vendor V in accordance with the information on arrival AI, and transmits the evaluation information for the sender S to the server 1 as the feedback information. Also, the product G is loaded on the moving body T and delivered to the customer C in accordance with the information on shipping SI. The service provider first causes the order information. OI1 and the placed order information OI2 to be transmitted from the sender terminal 3 or the like to the server 1 and converts them into the information on arrival AI and the information on shipping SI. Then, in accordance with the requests of the customer C, the sender S, and the distribution service provider L, a service (distribution plan generation process) for determining when, where, and by whom the moving body T is going is performed.

The user such as the sender S who uses the present service can convert the higher-order information (received-order information) on the sender S side to the lower-order distribution information when delivering the product G, and thus those (the sender and the third party) who are not the distribution side can make the distribution plan. Accordingly, it is possible to do distribution marketing the like through various types of simulations, analysis, or the like. Since the transport distribution plan can be generated (estimated) in advance, an optimal transport method can be selected in accordance with multiple transport routes or conditions.

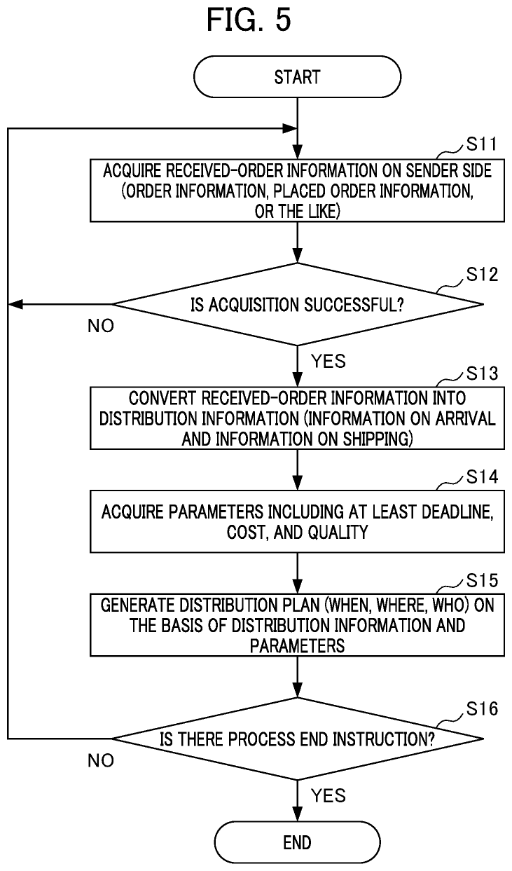

Next, the distribution plan generation process executed by the server 1 having the functional configuration illustrated of FIG. 3 will be described with reference to FIG. 5. FIG. 5 is a flowchart for describing the flow of the route determination process executed by the server 1.

In step S1, the received-order-information acquisition unit 61 acquires received-order information on the sender side (the order information, the placed order information, or the like). In step S2, the CPU 11 of the server 1 determines whether or not the received-order information is successfully acquired. If the received-order information is not transmitted from any of the sender terminals 3-1 to 3-m, it is determined as NO in step S2, and the process returns to step S1. On the other hand, the received-order information is transmitted from the sender terminal 3-P, it is determined as YES in step S2, and the process proceeds to step S3.

In step S3, the received-order-to-distribution conversion unit 62 converts the acquired received-order information into the distribution information (the information on arrival from the production/supply source and the information on shipping to the customer). In step S4, the parameter acquisition unit acquires the parameters including at least the deadline, the cost, and the quality (accident rate).

In step S5, the distribution-plan generation unit 64 generates the distribution plan (when, where, and who) on the basis of the distribution information converted in step S3 and the parameters acquired step S4. As described above, the method generating the distribution plan through the distribution-plan generation unit 64 is not particularly limited, and the service provider can freely select it. Further, in step S6, the CPU 11 of the server 1 determines whether or not there is an instruction to end the process. Here, the instruction to end the process is not particularly limited, but in the present embodiment, a power shutdown of the server 1 is employed. In other words, when the server 1 is powered off, it is determined as YES in step 36, and the process of the server 1 ends. On the other hand, unless the server 1 is powered off, it is determined as NO in step S6, the process returns to step S1, and the subsequent processes are repeated.

The embodiment of the present invention has been described above, but the present invention is not limited to the above-described embodiment. Further, the effects described in the present embodiment are merely a list of most preferable effects resulting from the present invention, and the effects of the present invention are not limited to those described in the present embodiment.

In the above-described embodiment, the items of the product type, the quantity, the delivery destination, and the deadline are selected as the order information, but these are only examples for explanation, and the present invention is not limited thereto.

Further, for example, in the above-described embodiment, the information such as the type, the quantity, and the deadline of the product to be ordered has been described as the placed order information, but the present invention is not limited thereto.

Also, for example, in the above-described embodiment, for example, the information on the capacity of the moving body (the size such as the 4 t vehicle or the 10 t vehicle) and the information on the type of the route service or the reserved service have been described as the moving body characteristic information, but these are merely illustrative examples, and the present invention is not particularly limited thereto. For example, any information indicating the characteristics of the moving body such as a vehicle model, fuel consumption, or the like of the moving body can be used. Further, for example, the moving body information may include information on the driver of the moving body, for example, the driver's compliance (including working conditions). Further, the distribution plan can be generated by combining completely different pieces of information other than the input information, the package characteristic information, and the moving body characteristic information.

Further, for example, in the above-described embodiment, the distribution plan generation method is not specifically mentioned, but the service provider may generate the distribution plan any method. For example, it is also possible to add a setting of discounting the cargo handling fee when a specific condition is met or a setting of discounting the storage fee when a package is stored in a specific region. Accordingly, the service provider can provide a service that is more convenient for the user by generating the distribution plan in a method that is optimal for the service itself.

Also, for example, the number of distribution plan candidates may be two or more. In a case in which there are a plurality of distribution plan candidates, a plurality of distribution plan candidates may be displayed on the same screen, or other distribution plan candidates may be displayed separately.

In the above-described embodiment, the information processing device of the present invention includes the server 1, the customer terminal 2, the sender terminal 3, the vendor terminal 4, and the distribution service provider terminal 5, but it is only an example to achieve the objects of the present invention, and the present invention is not particularly limited. For example, a terminal may be installed on the collection base or the moving body T and added to the configuration of the present invention.

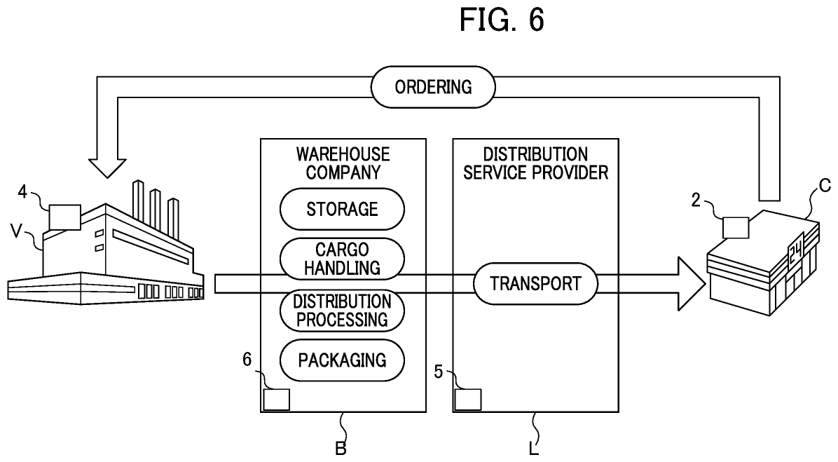

Further, a terminal may be installed in a warehouse company and added to the configuration of the present invention. In this case, for example, a service different from the example of FIG. 4 may be provided as the service performed by the service provider that executes the distribution plan generation process. Therefore, an example of the service different from that of FIG. 4 will be described below with reference to FIG. 6.

FIG. 6 is a diagram illustrating an example of the service different from that of FIG. 4 among the services performed by the service provider that executes the distribution plan generation process executed by the server 1 of FIG. 3.

Referring to FIG. 6, the customer C, the vendor V a warehouse company B, and the distribution service provider L exist. The customer C, the vendor V, the warehouse company B, and the distribution service provider L perform various types of processes by operating the customer terminal 2, the vendor terminal 4, a warehouse company terminal 6, and the distribution service provider terminal 5, respectively.

In an overview of the service illustrated in FIG. 6, if the customer C places an order for a product A (not illustrated) to the vendor V, the vendor V manufactures the product A. The product A manufactured by the vendor V is stored, handled, distributed, packaged, or the like in the warehouse company B and delivered to the customer C by the distribution service provider L.

That is, although not illustrated in FIG. 6, the received-order-information acquisition unit 61 of the server 1 receives the received-order information on the sender S side (the order information from the customer C, the placed order information to the vendor V (production/supply source), or the like) from the sender terminal 3 or the vendor terminal 4 through the communication unit 19. Further, the received-order-to-distribution conversion unit 62 converts the acquired received-order information into the distribution information. In the example of FIG. 6, the distribution information includes information used by the warehouse company B in addition to the information used by the distribution service provider L. The information used by the distribution service provider L is one in which a place at which a freight is loaded into a truck is a place designated by the vendor V in the case of another examples described above, but in the example in FIG. 6, a difference lies in that it is the warehouse managed by the warehouse company B, and the other points are similar. In other words, the distribution plan (when, where, and who) is generated on the basis of the deadline, the cost, and the quality (accident rate). The information used by the warehouse company B is various types of information necessary for storage, cargo handling, distribution processing, packaging, or the like, including information about warehouse inventory. Specifically, for example, information used in the following inventory management system is an example of the information used by the warehouse company B.

Here, the warehouse company terminal 6 of the warehouse company B manages all products stored in the warehouse of the warehouse company B, including the product A, using the inventory management system provided by the server 1. The inventory management system calculates how much empty space for storing freight exists in the warehouse of the warehouse company B from information on an operating rate of the warehouse of the warehouse company B, and manages the information obtained by the calculation as warehouse operating information. Further, the inventory management system regularly observes freight movement of all the products stored in the warehouse of the warehouse company B, including the product A, and detects seasonal demand factors for each product. The inventory management system manages information on the seasonal demand factors as seasonal information. For example, if a product is a can juice, information indicating that the freight movement is active in summer is managed as the information on the seasonal demand factors. Further, if product is a bowl, information indicating that the freight movement is active near the New Year managed as the information on the seasonal demand factors. The inventory management system generates support information for supporting increasing the operating rate of each warehouse on the basis of the warehouse operating information and the seasonal information. The generated support information is provided to the warehouse company B via the warehouse company terminal 6.

Further, information on the use of the empty space of the warehouse may be provided to the customer C via the customer terminal 2 when the operating rate of the warehouse is likely to drop or has already dropped. For example, the empty space of the warehouse may be used as a hub in terms of distribution for a certain period (for example, a short period of three months or the like). The warehouse fee may be an auction format in which networks of the service provider and the service user are used. As described above, by causing the information that has been managed separately by the customer C, the vendor V, the warehouse company B, and the distribution service provider L to be overconcentrated on the system, it is possible to induce the effective short-term use of the empty space by the warehouse company B. As a result, the empty space of the warehouse can be used as the hub in terms or distribution, and thus the efficiency of the transport of the distribution service provider L including the route operator in a punctured state can be improved.

Moreover, the hardware configuration illustrated in FIG. 2 is merely an example for achieving the objects of the present invention, and the present invention is not particularly limited.

Further, the functional block diagram illustrated in FIG. 3 is merely an example, and the present invention is not particularly limited. That is, as long as the information. processing system has the function capable of executing a series of processes described above as a whole, a functional block used to realize this function is not particularly limited to the example of FIG. 3.

Further, the location of the functional block is not limited to that illustrated in FIG. 3 but may be arbitrary. For example, at least some of the functional blocks on the server 1 side may be disposed on any one of the customer terminal 2 side, the sender terminal 3 side, the vendor terminal 4 side, and the distribution service provider terminal 5 side or vice versa. Further, one functional block may be configured with hardware alone or in combination with software alone.

Further, in the above-described embodiment, each of the customer terminal 2, the sender terminal 3, the vendor terminal 4, and the distribution service provider terminal 5 is configured with a smart phone but may be configured with an arbitrary device including a tablet or a future new device in addition to a smart phone.

In a case in which the process or each functional block is executed by software, a program that configures the software is installed in a computer or the like from a network or a recording medium. The computer may be a computer which is incorporated in dedicated hardware. The computer may be a computer capable of executing various types of functions by installing various types of programs such as a general-purpose smart phone or personal computer other than a server.

A recording medium containing such a program is not only configured with a removable medium which is distributed separately from a main body of a device in order to provide the program to each user but also a recording medium which is provided to each user in a state in which it is installed in a main body of a device in advance.

In the present specification, steps of describing the program to be recorded on the recording medium include not only, as a matter of course, processes which are executed chronologically according to its order but also processes which are executed in parallel or individually although not necessarily in chronological order.

In summary, the information processing device to which the present invention is applied is sufficient if the present invention has the following configuration, and various embodiments may be taken. That is, the information processing system to which the present invention is applied includes:
a received-order-information acquisition section (for example, the received-order-information acquisition unit 61 of FIG. 3) that acquires received-order information on a sender side (the order information from the customer, the placed order information to the production/supply source, or the like) from a sender terminal or a vendor (production/supply source) terminal;
a received-order-to-distribution conversion section (for example, the received-order-to-distribution conversion unit 62 of FIG. 3) that converts the acquired received-order information into distribution information (the information on arrival from the production/supply source and the information on shipping to the customer);
a parameter acquisition section (for example, the parameter acquisition unit 63 of FIG. 3) that acquires parameters including at least a deadline, a cost, and a quality (accident rate); and
a distribution-plan generation section (for example, the distribution-plan generation unit 64 of FIG. 3) that generates a distribution plan (when, where, and who) on the basis of the converted distribution information and the acquired parameters. By applying such information processing device, it is possible to provide a technique that enables those (the sender S and the third party) who are not the distribution side to make the distribution plan as the service provider can convert the higher-order information (received-order information) on the sender side into the lower-order distribution information. Accordingly, it is possible to do distribution marketing or the like through various types of simulations, analysis, or the like.

### EXPLANATION OF REFERENCE NUMERALS

1: SERVER, 2, 2-1 TO 2-m: CUSTOMER TERMINAL, 3, 3-1 TO 3-m: SENDER TERMINAL, 4, 4-1 TO 4-m: VENDOR. TERMINAI, 5, 5-1 TO 5-m: DISTRIBUTION SERVICE PROVIDER TERMINAL, 11: CPU, 18: STORAGE UNIT, 19: COMMUNICATION UNIT, 31: ORDERING UNIT, 32: FEEDBACK UNIT, 41: ORDER PLACEMENT UNIT, 51 : ORDER RECEPTION′ UNIT, 61: RECEIVED-ORDER-INFORMATION ACQUISITION UNIT, 62: RECEIVED-ORDER-TO-DISTRIBUTION CONVERSION UNIT, 63: PARAMETER. ACQUISITION UNIT, 64: DISTRIBUTION-PLAN GENERATION UNIT, 65: ACTUAL RECORD ACQUISITION UNIT, 66: NOTIFICATION UNIT, 67: REPORT GENERATION UNIT, 71: PARAMETER DB, 81 : DISTRIBUTION-PLAN ACQUISITION UNIT, 82: ACTUAL RECORD RECORDING UNIT, 83: FEEDBACK UNIT, CUSTOMER, S: SENDER, V: VENDER, L: DISTRIBUTION SERVICE PROVIDER, G: PRODUCT, T: MOVING BODY

1. An information processing system, comprising:
a received-order-information acquisition section that acquires received-order information on a sender side from a sender terminal or a vendor terminal;
a received-order-to-distribution conversion section that converts the acquired received-order information into distribution information;
a parameter acquisition section that acquires parameters including at least a deadline, a cost, and a quality; and
a distribution-plan generation section that generates a distribution plan on the basis of the converted distribution information and the acquired parameters.

2. The information processing system according to claim. 1, further comprising:
an actual record acquisition section that acquires an actual distribution record on the basis of the distribution plan; and
a notification section that notifies a timing for introducing the system on the sender side on the basis of a comparison result between the distribution plan and the actual distribution record.

3. The information processing system according to claim. 1, further comprising:
an actual record acquisition section that acquires a real actual distribution record based on the distribution plan; and
a report generation section that generates a report on distribution of the sender on the basis of a comparison result between the distribution plan and the actual distribution record.
